(19) United States
(12) Patent Application Publication
(10) Pub. No.: US 2026/0368255 A1
(43) Pub. Date: Nov. 19, 2026

(54) System and Methods for Providing Multimodal Search Query Suggestions

(71) Applicant: Google LLC, Mountain View, CA (US)

(72) Inventors: Kaan Yucer, San Francisco, CA (US); Cindy L. Huynh, San Francisco, CA (US)

(21) Appl. No.: 19/209,464

(22) Filed: May 15, 2025

(51) Int. Cl. G06F 16/9032; G06F 3/04842; G06F 16/432

(52) U.S. Cl. CPC G06F 16/90324; G06F 3/04842; G06F 16/434

(57) ABSTRACT

The present disclosure provides methods, systems, and devices for generating query suggestions for image-based queries. A system displays visual content in a user interface of an image display and processing application. The system receives user selection of a search function within the image display and processing application. The system updates the user interface of the image display and processing system to display a search interface. The system generates a representation of the visual content. The system generates a model input including the representation of the visual content. The system provides the model input to a plurality of query suggestion model simultaneously. The system receives a plurality of query suggestions from the plurality query suggestion models operating in parallel. The system displays the plurality of query suggestions in the search interface of the image display and processing application.

### FIELD

The present disclosure relates generally to sequence processing models. More particularly, the present disclosure relates to a system that provides query suggestions for searches that include a media element (e.g., an image).

### BACKGROUND

As the capability of large language machine-learned models increases, the services that those models can provide continue to expand. Image search applications allow users to search for information about particular images (or other visual media). However, users may not be aware of the total search capabilities made available by the image search application. As such, users may not enter the most useful searches. It is, therefore, useful to provide suggested queries. The suggested queries need to be provided in real time and need to include a variety of possible search queries.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can be performed by a computing system comprising one or more processors. The method comprises displaying visual content in a user interface of an image display and processing application. The method further comprises receiving user selection of a search function within the image display and processing application. The method further comprises updating the user interface of the image display and processing system to display a search interface. The method further comprises generating a representation of the visual content. The method further comprises generating a model input including the representation of the visual content. The method further comprises providing the model input to a plurality of query suggestion model simultaneously. The method further comprises receiving a plurality of query suggestions from the plurality query suggestion models operating in parallel. The method further comprises displaying the plurality of query suggestions in the search interface of the image display and processing application.

Another example aspect of the present disclosure is directed to a computing system for providing a query suggestion system. The system can include one or more processors and one or more non-transitory computer-readable media that collectively store instructions that, when executed by the one or more processors, cause the computing system to perform operations. The operations can comprise displaying visual content in a user interface of an image display and processing application. The operations further comprise receiving user selection of a search function within the image display and processing application. The operations further comprise updating the user interface of the image display and processing system to display a search interface. The operations further comprise generating a representation of the visual content. The operations further comprise generating a model input including the representation of the visual content. The operations further comprise providing the model input to a plurality of query suggestion model simultaneously. The operations further comprise receiving a plurality of query suggestions from the plurality query suggestion models operating in parallel. The operations further comprise displaying the plurality of query suggestions in the search interface of the image display and processing application.

Another example aspect of the present disclosure is directed to one or more non-transitory computer-readable media that collectively store instructions that, when executed by one or more computing devices, cause the one or more computing devices to perform operations. The operations can include accessing a plurality of synthesized images. The operations further comprise obtaining, for each synthesized image, one or more labels. The operations further comprise training a teacher model based to generate synthetic suggested query data using the plurality of synthesized images and the one or more labels for each synthesized image. The operations further comprise generating, using the teacher model, synthetic suggested query data. The operations further comprise creating suggested query training data by combining the synthetic suggested query data with existing query search log data. The operations further comprise training a query suggestion model to generate suggested queries based on an image using the suggested query training data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 represents an example of a search system for generating suggested queries based on visual content displayed in an image processing and recognition application in accordance with example embodiments of the present disclosure;

FIG. 2 depicts a query suggestion system in accordance with example embodiments of the present disclosure;

FIG. 3 depicts an example query suggestion system in accordance with example embodiments of the present disclosure;

FIG. 4 represents an example system for training a query suggestion system in accordance with example embodiments of the present disclosure;

FIG. 5 represents an example user interface for displaying a list of suggested queries in accordance with example embodiments of the present disclosure;

FIG. 6 depicts an example flow diagram for training a query suggestion system in accordance with example embodiments of the present disclosure;

FIG. 7 depicts a block diagram of an example computing system for generating suggested queries according to example embodiments of the present disclosure;

FIG. 8 depicts an example client-server environment according to example embodiments of the present disclosure;

FIG. 9 is a flow diagram representing a process for generating query suggestions based on visual content in accordance with example embodiments of the present disclosure;

FIG. 10 is a block diagram of an example processing flow for using machine-learned model(s) to process input(s) to generate output(s);

FIG. 11 is a block diagram of an example implementation of an example machine-learned model configured to process sequences of information;

FIG. 12 is a block diagram of an example technique for populating an example input sequence;

FIG. 13 is a block diagram of an example computing device that performs according to example embodiments of the present disclosure; and

FIG. 14 is a block diagram of an example computing device that performs according to example embodiments of the present disclosure.

Reference numerals that are repeated across plural figures are intended to identify the same features in various implementations.

### DETAILED DESCRIPTION

Generally, the present disclosure is directed toward a query suggestion system that generates suggested queries for an image-based search. To do so, a query suggestion system can be associated with an image processing and recognition application capable of recording imagery (e.g., one or more images or video), presenting imagery (e.g., images or video) on the screen of a user computing device, and receiving queries from users. When a user has a question about media content displayed in the application, the user can access a search feature of the image processing and recognition application. For example, users can select a search button or enter text into a search input field. The image processing and recognition application can initiate a query suggestion system in response to the user beginning a search.

The query suggestion system can generate a model input for a query suggestion model. The model input can be a prompt that includes the image (or a representation thereof), contextual information, and any text already provided by the user (e.g., as the user begins entering text in the input field). The query response model has been trained to generate suggested queries for the image based on the model input. The query response system can include a plurality of query suggestion models executed in parallel to generate a plurality of query suggestions with minimal delay. The one or more query suggestion model(s) can output a plurality of query suggestions for the image. The interface of the image processing and recognition application can be updated to display the plurality of query suggestions. As the user provides additional portions of a query (e.g., the user enters additional characters), the query suggestions system can generate an updated list of suggested queries.

A training system can employ a teaching model to produce synthetic training data to train the query suggestion system. In this way, the system does not need to use a large number of human labelers to generate initial training data. Thus, human labelers can label a small number of synthetic examples. Human labelers could be encouraged to prioritize query suggestions that are information-seeking and have high diversity. These examples can be used to train a teacher model that generates additional synthetic data. The synthetic data can be combined with logs of previously submitted user queries. The combined data can be used to train (e.g., fine-tune) the query suggestion model. In this way, the query suggestion model can be trained with synthetic data that is significantly less costly than human-labeled data.

For example, the user uses an image processing and recognition application to view an image of a shoe. The user selects a search input field to find information about the displayed shoes. In response to the user selecting the search input field, the query suggestion system can generate a model input for the query suggestion model. The input can include the image (or a representation of an image such as an embedding), any characters already entered by the user, and any context, such as user information provided by the user. The input can be provided to a query suggestion model, which can output a list of suggested queries for the image. In some examples, a plurality of query suggestion models are used to generate query suggestions in parallel to reduce the overall delay. The list of suggested queries can be displayed in the user interface to the user (e.g., in a drop-down menu below the search input field) for selection by a user.

More particularly, a query suggestion system can be associated with an image analysis and recognition application that can capture video or images, display the video or images in an interface, receive queries related to the video or images, and provide a query response to the user. For example, the application can be an application that captures visual content and enables users to submit queries about the captured visual content.

The image processing and recognition application can be accessed by the user via the user computing device. A user computing device can be one of a personal computer, laptop, smartphone, smartwatch, tablet computing, wearable computing system, or any other computing system available to a user that can capture visual content and display that visual content in an interface. The user computing device can include the capability to communicate via computer networks. The image processing and recognition application can enable the user to capture or receive media elements (e.g., images, videos, audio, interactive elements, and so on.) In some examples, the user computing device can include a camera, an audio sensor, or any other sensors capable of capturing images, videos, and so on.

Using the image processing and recognition application, the user computing device can allow the users to capture visual content (or access previously captured visual content from a remote server system). The image processing and recognition application can display the captured media elements in its user interface. In some examples, the user may wish to conduct a search related to the displayed visual content or some portion thereof. In some examples, the user interface can include a search button. The search button can be a user interface element (e.g., a button) that, when selected, causes the user interface to update to display a search interface. The search interface can include a search input field in which the user can enter search queries. In other examples, the search interface can be a search field displayed within the user interface (e.g., at the top or bottom) where the user can enter text. In some examples, when the user accesses the search interface, the image processing and recognition application can initiate communication with a query suggestion system to provide suggested search queries to the user.

The query suggestion service can be provided by an application on the user computer device or by an application available at a remote computing system via a computer communication network. If a remote computing system provides the query suggestion service, the remote system can be a computing system such as a server system or other system that receives requests via a computer communication network and provides responses via the same network. In some examples, the server computer server can provide an application programming interface (API) that allows the image processing and recognition application to submit specific requests according to the format defined by the API and receive responses from the query suggestion service. In this case, the request can include an image or a representation of the image (such as an embedding) as well as any other information, such as any information provided by the user.

In some examples, the visual content (e.g., an image or video) can be processed before being transmitted to the query suggestion service. For example, an image can be embedded into an embedding space. In some examples, generating an embedding for a particular image can be accomplished by providing the image to a machine-learned model, and the machine-learned model can output an embedding that represents that image in the embedding space. The embedding can be a vector representation of the image. In some examples, other representations of the media element can be generated. For example, the system can generate a textual description of the media element. The textual description can be generated by a machine-learned model that takes visual content (e.g., videos or images) as input and generates a textual description of the contents of that image or video.

The query suggestion service can generate a model input based on the received information. The model input can include the visual content or a representation of the visual content. As noted above, the representation of the visual content can include an embedding of the visual content (e.g., a vector representation of the image) or a textual description of the semantic content of the visual content). In addition, the model input can include any text already entered by the user, any appropriate context, information about the user's intent, or any information about the user and their past interactions with the query suggestion service.

Once the model input has been generated, the model input can be provided to the query suggestion model. In some examples, the query suggestion service includes a plurality of query suggestion models that can be operated in parallel. Thus, the model input can be provided to one or more query suggestion models, and each of the one or more query suggestion models can output one or more query suggestions. For example, if only one query suggestion model is used, the single model can output a list of query suggestions. If a plurality of query suggestion models are used, each model can output a query suggestion. In this way, a large number of query suggestions can be generated within a relatively small amount of time.

The query suggestion service can combine the outputs from a plurality of query suggestion models into a list of query suggestions. The query suggestion service can return the list of query suggestions to the user computing device. The user computing device can display the list of query suggestions. In some examples, the list of suggested queries can be displayed below the search input field. In some examples, the user can select a query suggestion from the displayed list of query suggestions. If so, the selected query suggestion can be provided to a multimodal search system.

In some examples, the multimodal search system can receive the selected query and the displayed visual content as input. The multimodal search system can include a machine-learned model that takes a query and visual content as input and outputs a response to the query based, at least in part, on the visual content. The model response can be provided to the user.

The query suggestion model needs to be trained using data that can identify useful queries based on specific visual content. It can be difficult to obtain a large amount of data that associates queries with visual content. One reason for this is that the actual queries submitted by users previously may include images that, for privacy reasons, are not available to the training system. In addition, the previous queries may not have the diversity or information seeking qualities that result in high quality suggestions by the model. As a result, additional training data is needed to ensure that the query suggestion model is trained to provide useful suggested queries. A training system can receive labelled images from human labelers. Human labelers can be provided with a plurality of synthetic images. The human labelers can receive instructions requesting that they provide one or more suggested queries (e.g., labels) for each synthetic image. The instructions can also instruct the human labelers to provide suggested queries that are information seeking, diverse, and are designed to access one or more underused features of the query response system. The resulting examples are high quality but are expensive to produce.

The human-labeled data can be used to train a teacher model. The teacher model can, once it has been trained by the human labeled data, generate synthetic training data. The synthetic training data can include a plurality of images (e.g., synthetic images) and, for each image, one or more suggested queries. The teacher model can thus be trained to generate a large amount of synthetic data with much less cost than the cost of human-labeled data.

The synthetic data can be combined with log data representing previous user-submitted queries. The log data can include images and suggested queries. The teacher model can generate a large amount of this synthetic data that can be combined with the existing log data. The combined synthetic data and log data can then be used to train the query suggestion model. Note that the query suggestion model can begin with a base generative model that has previously been trained generally to provide responses to queries and is then fine-tuned using the synthetic data and the log data to provide output of query suggestions based on input that includes images (or representations thereof such as embeddings or textual descriptions).

Once the base model has been fine-tuned, it can act as a query suggestion model, and output query suggestions based on input that includes image data and query data. In this way actually no model can be trained with synthetic data to provide useful query suggestions based on the image.

The systems and methods of the present disclosure provide a number of technical effects and benefits. As one example, the systems and methods can reduce the latency, and the number of computational resources needed to generate a useful query suggestion for a multimodal search. Specifically, using an embedding of an image can enable the system to quickly and accurately determine one or more suggested queries for a query based on that image. Doing so can significantly reduce the time and cost needed to produce useful query responses results for a machine-learned model. In addition, suggested queries can make users aware of the abilities of a search system that they may not be aware of.

Another example technical effect and benefit relates to improved computational efficiency and reduced latency in a computing system. For example, a technical benefit of the systems and methods of the present disclosure is the ability to use multiple query suggestion models in parallel to generate a plurality of suggestions at one time. Doing so can enable the system to generate a large variety of query suggestions without increasing the total amount of time needed. This allows for more useful suggestions without increasing the time the user waits for those suggestions to be displayed.

With reference now to the Figures, example embodiments of the present disclosure will be discussed in further detail.

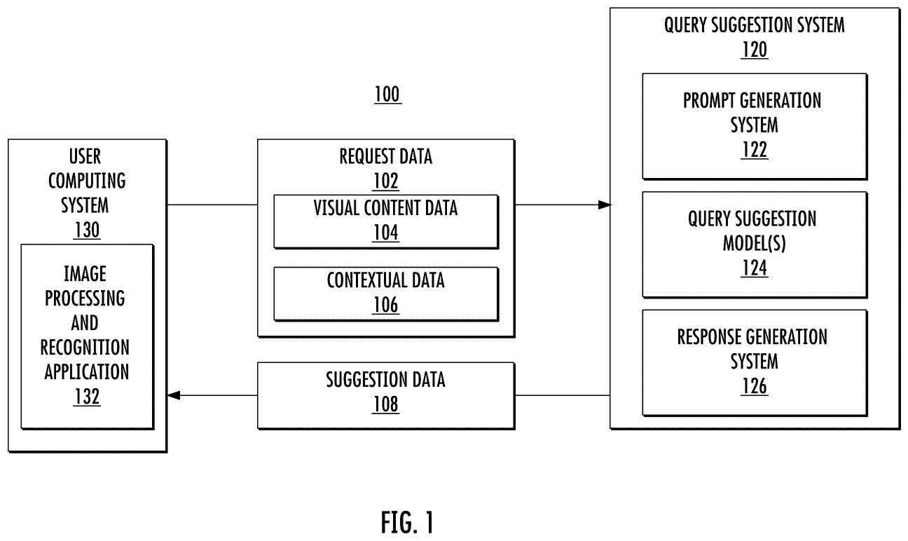

FIG. 1 represents an example of a search system 100 for generating suggested queries based on visual content displayed in an image processing and recognition application in accordance with example embodiments of the present disclosure. In this example, a user can access an image processing and recognition application 132 using a user computing system 130. The image processing and recognition application 132 can enable the user to capture (e.g., via a camera or other sensor included in the user computing device) or access (e.g., via a computing network) visual content. The visual content can include images, videos, interactive content, and so on. The image processing and recognition application 132 can present the visual content to the user (e.g., display in a user interface).

In some examples, the user may have a question about the displayed visual content. If so, the image processing and recognition application 132 may include a search feature. The search feature may be represented by a selectable element in the user interface (e.g., a button) or may include a selectable search input field. In some examples, the user can select the search feature by selecting the element (e.g., a button in the user interface) or selecting the search input field (clicking on the input field or touching a touch screen near the search input field) to enable text to be entered to the search input field. In some examples, the user can also interact with the interface of the image processing and recognition application 132 to select a portion of the visual content. For example, the user can highlight or otherwise indicate a particular portion of an image that is of interest to the user. If so, only the selected portion will be used to determine suggested queries.

In some examples, once the user has selected the search feature, the image processing and recognition application 132 can provide a list of query suggestions. Providing a list of query suggestions can reduce the time the user needs to enter their query. In addition, the suggested queries can make the user aware of additional features or potential queries that the image processing and recognition application 132 can execute that the user may not have been aware of. This allows users to be made aware of new features or additional ways to use existing ones.

In some examples, the image processing and recognition application 132 uses a query suggestion system 120 to generate suggested queries. For example, existing query suggestion systems may be unable to generate appropriate query suggestions based on visual content. Instead, a multimodal query suggestion system (such as a query suggestion system 120) may be needed to generate helpful and accurate query suggestions. In some examples, the user computing system 130 can generate request data 102. The request data can be transmitted to the query suggestion system 120. In some examples, the query suggestion system 120 can be included in the user computing system 130. In other examples, the query suggestion system 120 is provided by a remote service, and the request data 102 is transmitted to a user computing network to the remote service.

The request data 102 can include visual content data 104 and contextual data 106. The visual content data 104 can include data representing the visual content displayed in the user interface of the image processing and recognition application 132. In some examples, the visual content data 104 can represent the entire piece of visual content or a selected portion of the visual content (e.g., selected by the user). In another example, the visual content data 104 can be an embedding that represents the visual content within a particular embedding space. For example, image or video data can be provided to an embedding model, and the embedding model can output an embedding that represents the image within that embedding space. The embedding can be a vector representation of the visual content.

In some examples, the visual content data 104 can include a textual description of the visual content displayed in the image processing and recognition application 132. For example, a particular machine-learned model can be trained to take a piece of visual content as input and output a textual description of the visual content. The textual description can be one or more labels describing the content generally. Additionally, or alternatively, the written description can include a natural language description of the contents of the visual content.

The request data can also include contextual data 106 contextual data can be information about the specific request, including information that the user has provided, past user interactions with the system, determining user intents, and text the user has already inputted. For example, the user can enter characters to the search input field on character at a time or a small group of characters at a time. The image processing and recognition application 132 can generate updated request data 102 in response to each character that is entered. The list of suggested queries can be updated based on each new character entered by the user.

The query suggestion system 120 can receive the request data 102. In some examples, if visual content data 104 includes a raw representation of the visual content, the query suggestion system 120 can provide it to an embedding system. An embedding system can generate an embedding representing the visual content within a particular embedding space. In some examples, the embedding system can include a machine learning model that takes visual data files and outputs embedded representations of the visual data files.

In some examples, the query suggestion system 120 can provide the request data 102 to a prompt generation system 122. The prompt generation system 122 can generate a prompt based on the data provided in the request data 102. The prompt can include the visual content data 104 and the contextual data 106. The prompt can also include instructions directing the query suggestion model 124 to perform particular actions (e.g., requesting the model to output query suggestions based on the input). In some examples, the query suggestion system 120 includes a plurality of query suggestion models 124. If so, the prompt generation system 122 can generate a plurality of prompts. The plurality of prompts can be identical or may have slight variations to ensure that the output from the query suggestion models 124 provides a variety of different query suggestions.

Once the prompt has been generated by the prompt generation system 122, the prompt could be provided to the one or more query suggestion models 124. The query suggestion models 124 can take the prompt as input and provide one or more query suggestions as output. Query suggestions can be words or phrases. The query suggestion model(s) 124 can be trained to provide query suggestions that are diverse and information-seeking. In this way, the output of the query suggestion model 124 can include a variety of different suggested queries.

The response generation system 126 can receive the plurality of query suggestions from one or more query suggestion models 124. The response generation system 126 can filter and order the query suggestions. For example, to filter the query suggestions the response generation system 126 can determine whether any query suggestions are very similar to other query suggestions. If so, any duplicative suggestions can be removed. In some examples, the response generation system 126 can provide an order for the list of query suggestions (e.g., if multiple query suggestions models 124 provide the suggestions or otherwise are initially unordered). To do so, the query suggestions can be ranked for correctness, information seeking qualities, and diversity. Once the plurality of query suggestions have been ordered, the response generation system 126 can generate the suggestion data 108. The suggestion data 108 can be transmitted to the user computing system 130. The image processing and recognition application 132 can receive the suggestion data 108 and display the query suggestions to the user within the interface of the image processing and recognition application 132. For example, if the image processing and recognition application 132 includes a search input field, the query suggestions can be displayed below that field for the user to select as they input their query.

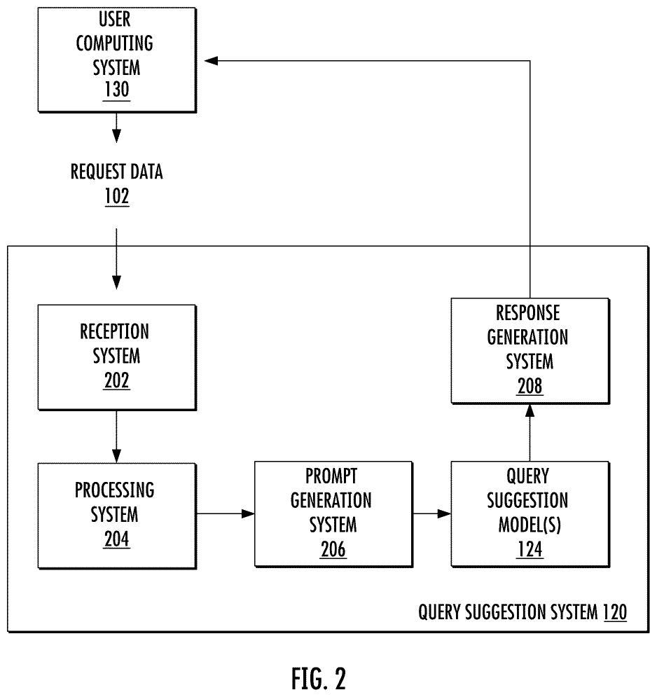

FIG. 2 depicts a query suggestion system in accordance with example embodiments of the present disclosure. In this example, the query suggestion system 120 receives a request data 102 from a user computing system 130. The request data 102 can be obtained from the user computing system 130 while the user computing system 130 executes an image processing and display application associated with the query suggestion system 120. The application can enable the user computing system 130 to capture videos or images, display those videos or images on the screen of the user computing system 130, and receive input from a user to generate a search based on the displayed visual content.

In some examples, the request data 102 can include the visual content and any accompanying contextual data. For example, the contextual data can include information about the user and past interactions with the application and/or the query suggestion system 120. In some examples, the visual data can be a portion of the displayed visual data the user selects. The request data 102 can also include video or image data based on the video or images displayed in the application on the user computing system 130. For example, a user can view a video in the interface of their computing device (e.g., using an image capture and display application), and initiate input of a query about something depicted in the video. In that case, relevant portions of the video can be captured by the image capture and display application and transmitted to the query suggestion system 120. The user can manually select the portions of the video to send. In other examples, the application can automatically select portions of the video to send. For example, if the user pauses the video to initiate a query, the application can automatically select the paused portion or one or more previous portions and transmit those portions as part of the request data 102.

In some examples, the user can annotate the visual data to provide additional information. The request data 102 can be received by the reception system 202. The reception system can be within the query suggestion system 120, which provides an application programming interface (API). This API provides standardized methods for transmitting request data 102 to receive query suggestions from user computing devices.

The reception system 202 can transmit the request data 102 to the processing system 204. The processing system can process the incoming request data. In some examples, the request data includes image or visual data, and the processing system 204 can generate a representation of the data that a machine-learned model can use as input. For example, processing system 204 can use an embedding model to generate an embedding for the image and/or videos. The embedding can represent the image or other visual content and its place within a particular embedding space. This can give information about the type of content included in the visual content and allow the suggestion generation model to identify similar images or other visual content based on its training.

The processing system 204 can also generate textual descriptions of the visual content. For example, a machine-learned model can be trained to take images and or videos as input and output information describing the content of the image or video. For example, the output can be one or more labels describing the content, including the visual content, or the output can be a more detailed sentence describing the contents of the visual content. The processing system 204 can transmit any embeddings and/or textual descriptions to the prompt generation system 206.

The prompt generation system 206 can generate a prompt for use as input to the query suggestion model. The prompt can include an embedding of the image, a textual description of the image, and any other contextual information received as part of the request data 102. The prompt can include directions to the query suggestion model that explain that the outcome from the response generation model should be one or more suggested queries based on the input information. In some examples, the input information includes one or more characters entered by the user. This information can be included in the prompt, and all suggested queries can begin with the same text the user has entered.

The query suggestion model 124 can receive the prompt as input. The query suggestion model 124 can be trained to generate one or more suggested queries based on the data included in the prompts. In some examples, the query suggestion model 124 can be trained to generate information-seeking and diverse queries. In some examples, the query suggestion system 120 includes a plurality of query suggestion models 124. Each response generation model 124 can be assigned to generate a single query suggestion. In this way, a plurality of suggested queries are generated in parallel. The generated query suggestions can be transmitted to the response generation system 208.

The response generation system 208 can combine the suggested queries from a plurality of query suggestion models into a single list of query suggestions. In some examples, the response generation system 208 can determine whether any of the query suggestions are similar and remove similar suggested queries. In addition, the response generation system 208 can determine the total number of query suggestions to submit. In some examples, the response generation system 208 can verify that all of the generated suggested queries match the text already provided by the user. For example, if the user has provided the letters “CA,” the response generation system 208 can determine whether all query suggestions begin with the letters “CA” or are associated with the letters “CA” in some way. The list of query suggestions can be transmitted to the user computing system. The user computing system 130 can display the list of suggested queries to the user. Users can select one of those suggested queries by clicking on it or otherwise selecting a query. A query response system can then conduct a multimodal search using the selected query.

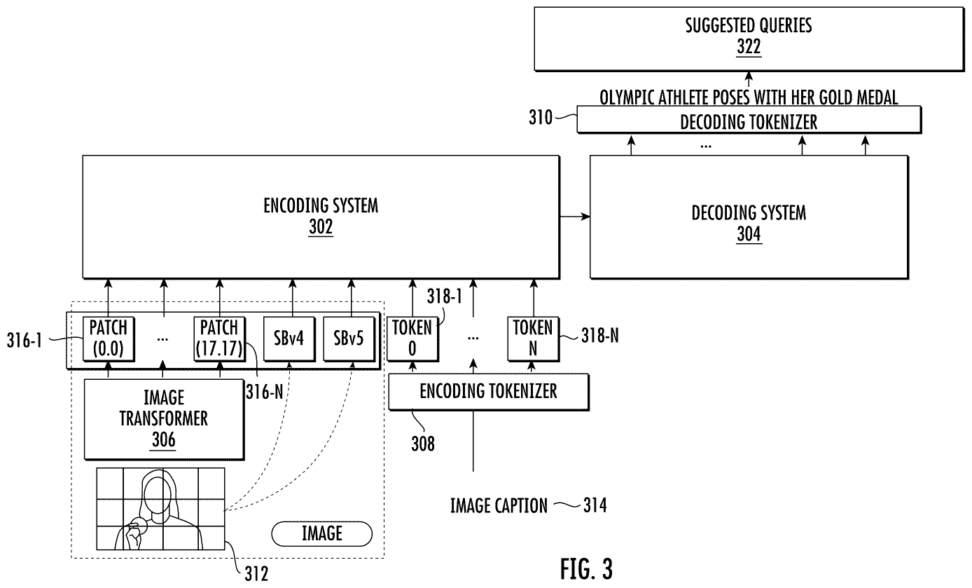

FIG. 3 depicts an example query suggestion system 120 in accordance with example embodiments of the present disclosure. A query suggestion system 120 can include an encoding system 302, an image transformer 306, an encoding tokenizer 308, a decoding system 304, and a decoding tokenizer 310. In this example, an image 312 can be provided to the query suggestion system 120. The input can also include an image caption 314. The image can be provided to an image transformer 306. In some examples, the image transformer 306 can use multi-head self-attention to process the image data. To do so, the image transformer 306 can decompose the image 312 into a series of patches (316-1 to 316-N). The series of patches (316-1 to 316-N) can be serialized into a vector, and matrix multiplication can be used to generate vector embeddings. The vector embeddings can be provided to the encoding system 302. In some examples, one or more portions of the image data can be provided directly to the encoding system 302.

In some examples, an image caption 314 can be generated or retrieved for the image. The image caption 314 can be provided to an encoding tokenizer 308. The encoding tokenizer 308 can encode the image caption 314 as a series of tokens (318-1 to 318-N). The series of tokens (318-1 to 318-N) can be provided to the encoding system 302.

The encoding system 302 can take the embedded image data, any other image data, and the tokens as input. The encoding system 302 can then process the input to generate contextualized embeddings of the input. For example, the encoding system can use a transformer-based architecture to process the input through multiple layers of self-attention and feed-forward neural networks. The encoding system 302 can use shared parameters across modalities to enable the contextualized embeddings to represent relationships and interactions between different types of input (e.g., image embeddings, text-based tokens, and so on).

The output of the encoding system 302 (e.g., a tensor or other data) can be provided to the decoding system 304. The decoding system 304 can use the contextualized embeddings generated by the encoding system 302 to generate meaningful outputs based on the embeddings. To do so, the decoding system 304 can include multiple decoding layers with self-attention and cross-attention mechanisms. The decoding system 304 can also employ an output head that can map the output of the decoder to a useful format. A variety of different system configurations and components can be used to generate a decoded output.

In some examples, the decoding tokenizer 310 can generate a general understanding of the image as well as the context provided by the user. In this example, the output can be “an Olympic athlete poses with her gold medal.” This representation of the image can be used to generate suggested queries 322. In some examples, suggested queries can be filtered to ensure they match the already existing input from the user and that none of the suggested queries overlap (e.g., they are sufficiently diverse).

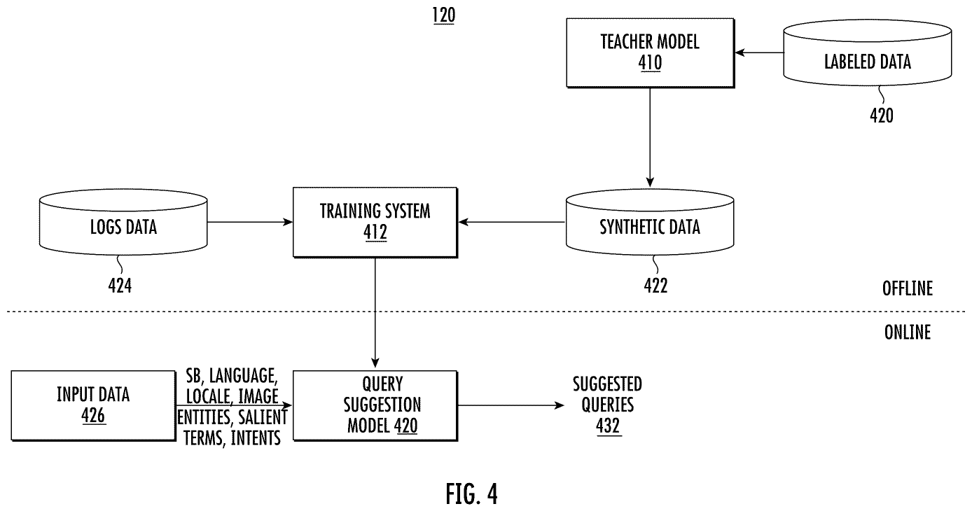

FIG. 4 represents an example system for training a query suggestion system 120 in accordance with example embodiments of the present disclosure. In this example, training system 412 can train a query suggestion model 420 to provide useful suggested queries for multimodal searches. In some examples, accessing enough training data to adequately train query suggestion models, such as the query suggestion model 420, can be difficult and/or expensive. To overcome this problem, the training system 412 can utilize a teacher model 410. The teacher model 410 can be trained using labeled data 420 to learn to generate synthetic data 422.

In this example, the labeled data includes an image and one or more human-written suggested queries. The human-written suggested queries can be referred to as labels/In some examples, human labelers can be instructed on the types of queries to be generated. For instance, human labelers may be instructed to write queries that are information-seeking, have a wide variety of topics, and are not duplicative. This labeled data can be provided as a tool for training the teacher model 410. In some examples, a relatively small amount of labeled data 420 can be used to adequately train the teacher model 410 to produce synthetic data 422.

In some examples, the teacher model 410 can produce synthetic data 422, including images and a plurality of suggested queries associated with that image. In some examples, the amount of synthetic data is much more significant than the amount of labeled data (e.g., orders of magnitude more). Using a teacher model 410, the training system 412 can avoid the costly process of manually generating suggested labels.

Once the synthetic data 422 has been generated, the training system 412 system can access the synthetic data 422 and log data 424. Log data 424 can include query queries previously submitted by users. In some examples, the log data 424 does not include the actual image submitted by the user (e.g., the user has not explicitly permitted it to be used). Instead, the training system 412 can identify similar images from a list of training examples. For example, for a particular logged search query, the training system 412 can identify a most similar image from a plurality of available images.

Using the combination of the log data 424 and the synthetic data 422, the training system 412 can train the query suggestion model 420 to provide one or more query suggestions based on input data. Because the synthetic data 422 was generated by a teacher model 410 that prioritizes information-seeking queries and queries that have a wide variety of topics or subjects, the query suggestion model 420 is trained to provide output that includes a wide variety of suggested queries including information seeking queries. In some examples, a query response system can have a plurality of capabilities for responding to different types of queries. The list of suggested queries can include suggested queries that access a variety of capabilities of the query response system. In this way, the suggested queries can result in users becoming aware of capabilities that the users did not previously know.

The input data 426 can include a variety of information. For example, the input data can include the language, locale, image data, salient terms, and intents associated with the prospective query. In some examples, the imagery can be embedded, and the salient terms and intents can be determined based on text associated with the images or user actions prior to the beginning of a search. In some examples, the user intents and salient terms can be generated by analyzing the user's history and past actions.

The input data 426 can be provided to the query suggestion model 420. The query suggestion data 120 has been trained based on the training system for 412 to generate one or more suggested queries. The query suggestion model 420 (or a plurality of query suggestion models) can output the plurality of query suggestions 432. The plurality of query suggestions 432 can be transmitted to the user computing device for display to a user.

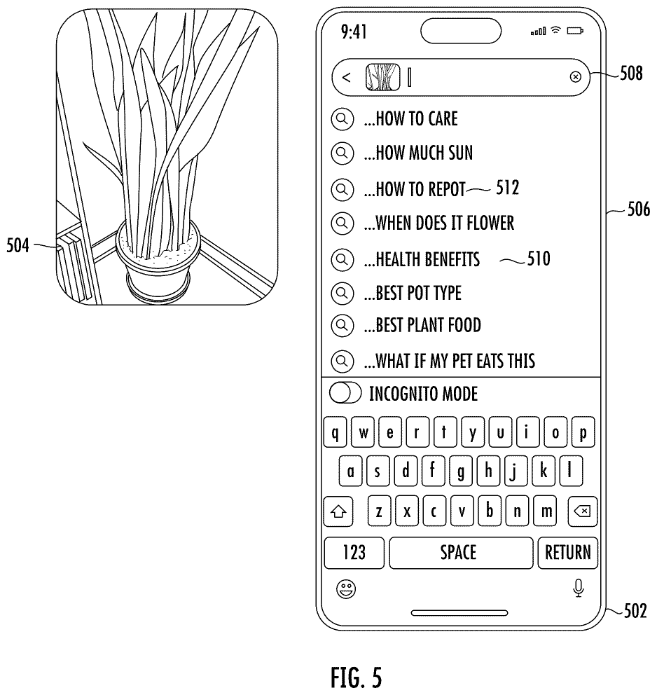

FIG. 5 represents an example user interface 500 for displaying a list of suggested queries in accordance with example embodiments of the present disclosure. In this example, the particular image 504 can be displayed in an image processing and analysis application being executed by a user computing device 502. The user can initiate a search by selecting a user input field 508 in the user interface 506. When the user selects the user input field 508, the query suggestion system can submit the image and any relevant data to a query suggestion model. The query suggestion model can output a list of suggested queries 510.

Once the list of suggested queries 510 has been generated, the list of suggested queries can be displayed in the user interface of the image processing and display application. In this example, the search interface includes a small reproduction of the image to be searched and a user input field 508. Below the user input field 508 is a list of suggested queries 510. Each suggested query is selectable. For example, if the user wishes to select a particular suggested query 512. In this case, the selected suggested query 512 can be “how to repot.” The user can click on the suggested query 512 or touch the screen on that suggested query 512. This query can then be submitted to a query response system with the associated image.

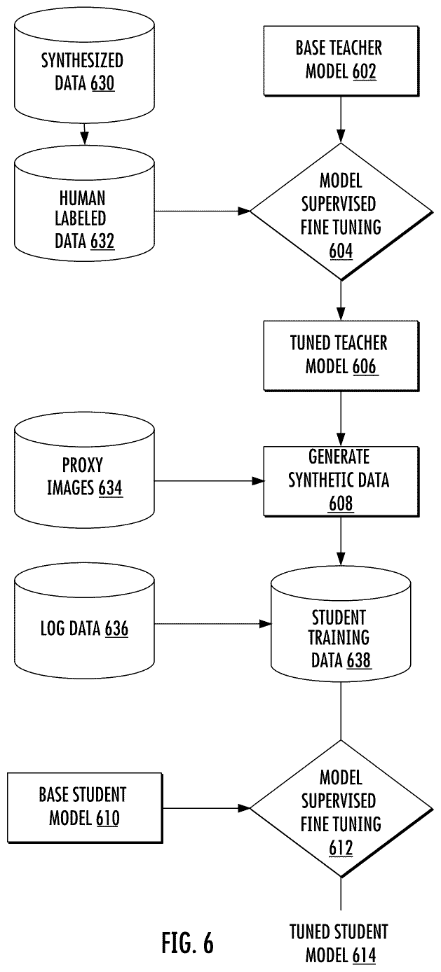

FIG. 6 depicts an example flow diagram for training a query suggestion system 120 in accordance with example embodiments of the present disclosure. In this example, a training system can access a base teacher model 602. The base teacher model 602 can be an existing sequence processing model that can generate responses to queries but has not been specifically trained to provide the teacher output needed for this training. To train the base teacher model 602, the training system can access synthesized data 630. Synthesized data can be images that are synthetically generated to represent a variety of images that may be provided to a query response system. Human labelers can provide labels for the variety of images. The labels can include one or more query suggestions associated with each synthesized image in the synthesized data 630.

The human-labeled data 632 can be generated to provide a variety of different query suggestions with a priority on information seeking queries. Using the human-labeled data 632, the base teacher model 602 can be fine-tuned. This process can be referred to as model-supervised fine-tuning 604. The base teacher model 602 can take synthesized data 630 as input and evaluate the output based on the human-labeled data 632. Fine-tuning the teacher model can enable the teacher model to output appropriate query suggestions based on the input image from the synthesized data 630.

Once the fine-tuning process has completed, the result will be a tuned teacher model 606. A tuned teacher model can be trained to output synthetic data that includes synthetic images and generated query suggestions. A plurality of proxy images 634 can be accessed. The proxy images 634 can be processed by the tuned teacher model 606 to generate a plurality of synthetic data 608. The amount of generated synthetic data can be significantly greater than the amount of human-labeled data 632.

Once a large amount of synthetic data has been generated, it can be combined with existing log data 636 into student training data 638. In some examples, the training system can access the base student model 610. The base student model 610 can be an existing machine-learned model that has not been specifically trained to produce query suggestions. Using the base student model 610 and the student training data 638, the training system can perform model fine-tuning 612 on the base student model 610. This fine-tuning 612 can train the base student model 610 to provide query suggestions for multimodal searches and produce a tuned student model 614. This tuned student model 614 can be used as a query suggestion model to generate query suggestions as needed.

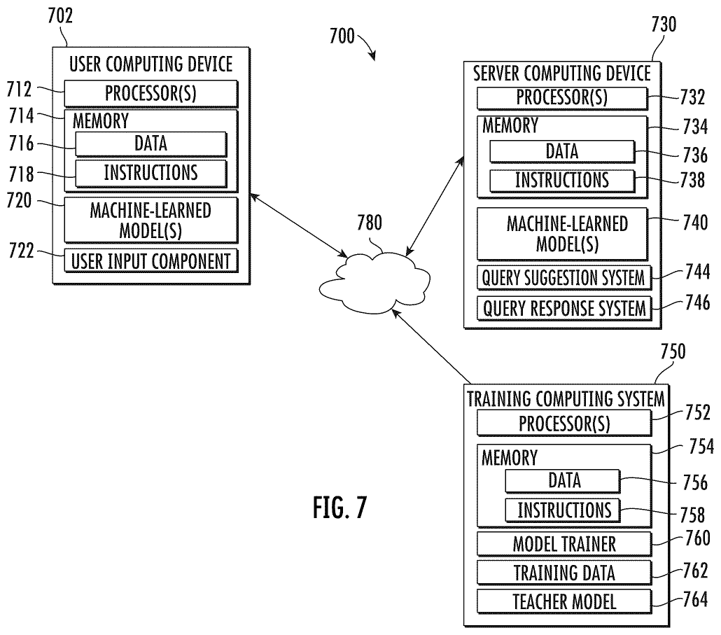

FIG. 7 depicts a block diagram of an example computing system 700 for generating suggested queries according to example embodiments of the present disclosure. The computing system 700 includes a user computing device 702, a server computing system 730, and a training computing system 750 that are communicatively coupled over a network 780.

The user computing device 702 can be any type of computing device, such as a personal computing device (e.g., laptop or desktop), a mobile computing device (e.g., smartphone or tablet), a gaming console or controller, a wearable computing device, an embedded computing device, or any other type of computing device.

The user computing device 702 includes one or more processors 712 and a memory 714. The one or more processor(s) 712 can be any suitable processing device (e.g., a processor core, a microprocessor, an ASIC, an FPGA, a controller, a microcontroller, etc.). The one or more processor(s) 712 can be one processor or a plurality of processors that are operatively connected. The memory 714 can include one or more non-transitory computer-readable storage mediums, such as RAM, ROM, EEPROM, EPROM, flash memory devices, magnetic disks, etc., and combinations thereof. The memory 714 can store data 716 and instructions 718, which are executed by the processor 712 to cause the user computing device 702 to perform operations. The user computing device 702 can include one or more user input components 722. The user input components 722 can include keyboards, touch-screens, computer mice, audio input, controllers, and so on.

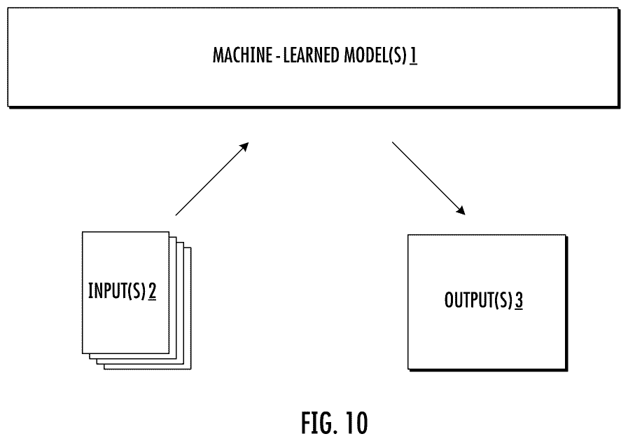

In some implementations, the user computing device 702 can store or include one or more machine-learned models 720 (e.g., a query suggestion model, a teaching model, a query response model, and so on). For example, the machine-learned models 720 can or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, or other forms of neural networks. Example machine-learned models 720 are discussed with reference to FIGS. 10-14.

In some implementations, the one or more machine-learned models 720 can be received from a server computing system 730 over network 780, stored in the memory 714 of the user computing device 702, and then used or otherwise implemented by the one or more processors 712. In some implementations, the user computing device 702 can implement multiple parallel instances of a single machine-learned model 720.

More particularly, the machine-learned model 720 (e.g., a sequence processing model) can generate suggested queries for particular images or videos. For example, when a user accesses the search capability of the image recognition and process application, the application can initiate communication with a query suggestion service. The image or video can be embedded and provided to the query suggestion service as input to a model. Based on the input, the query suggestion service can generate a list of suggested queries for the user.

In some examples, the query suggestion service includes a query suggestion model that takes, as input, information about the image or video and any information about the context of the search or any characters already entered by the user. For example, when the user selects the search option, the query suggestion service can generate input for the model. The input can include a representation of the image (or video). The representation can be an embedding representing the image within a particular embedding space, a textual description of the contents of the image, or a combination of both.

In some examples, the contextual information included in the model input can include information supplied by the user about the user characteristics, previous interactions with the user, information about the user's intent, and any text already entered by the user (e.g., the user can enter the input one character at a time.) This information can be included in the model input. The model input can be a prompt to the query suggestion model. The query suggestion model can take the model input as input, process the model input, and output one or more suggested queries.

In some examples, the query suggestion service includes a plurality of query suggestion models, each run in parallel so that a list of suggested queries is generated simultaneously. Once the list of suggested queries has been received, the suggested queries can be compared to determine whether any of the suggested queries are duplicative. In some examples, suggested queries can be ranked based on the degree to which they meet predetermined standards such as quality, diversity, and the degree to which they are information-seeking.

Once the list of suggested queries has been evaluated, a plurality of the suggested queries can be transmitted to the image search and evaluation application for display to the user. The user can then, if they wish, select one of the suggested queries. The selected query can be transmitted to a query response model that generates a response to the query based on the selected query, the image, and any other contextual information.

The server computing system 730 includes one or more processors 732 and a memory 734. The one or more processors 732 can be any suitable processing device (e.g., a processor core, a microprocessor, an ASIC, an FPGA, a controller, a microcontroller, etc.) and can be one processor or a plurality of processors that are operatively connected. The memory 734 can include one or more non-transitory computer-readable storage mediums, such as RAM, ROM, EEPROM, EPROM, flash memory devices, magnetic disks, etc., and combinations thereof. The memory 734 can store data 736 and instructions 738, which are executed by the processor 732 to cause the server computing system 730 to perform operations.

In some implementations, the server computing system 730 includes or is otherwise implemented by one or more server computing devices. In instances in which server computing system 430 includes plural server computing devices, such server computing devices can operate according to sequential computing architectures, parallel computing architectures, or some combination thereof.

As described above, the server computing system 730 can store or otherwise include one or more machine-learned models 740 (e.g., a sequence processing model, a query suggestion model, a query response model, a teacher model, or other machine-learned models used by a query response system). For example, the models 740 can be or can otherwise include various machine-learned models. Examples of machine-learned models include neural networks or other multi-layer non-linear models. Example neural networks include feed forward neural networks, deep neural networks, recurrent neural networks, and convolutional neural networks. Example models 740 are discussed with reference to FIGS. 10-14.

The server computing system 730 also includes a query response system 744. The query suggestion system 744 can receive a request from an application on the user computing device 702. In response, the query response model can generate model input, including information about an image or video, contextual information, information about the user intent, and other information as input to a query suggestion model. The query suggestion model can use the input to generate a model output. The model output could include a list of suggested queries. The list of suggested queries can be transmitted to the user computing device 702 and displayed to the user.

In some examples, the user can select a particular query suggestion. The selected query suggestion can be transmitted to the server computing system 730. The server computing system 730 can use the query response system 746 to generate a response to the selected query. In some examples, the query response system 746 is not stored on the same server computing system 730 as the query suggestion system 744.

The user computing device 702 and/or a server computing system 730 can train the models 720 and/or 740 via interaction with the training computing system 750, which is communicatively coupled over the network 780. The training computing system 750 can be separate from or a portion of the server computing system 730.

The training computing system 750 includes one or more processors 752 and a memory 754. The one or more processors 752 can be any suitable processing device (e.g., a processor core, a microprocessor, an ASIC, an FPGA, a controller, a microcontroller, etc.) and can be one processor or a plurality of processors that are operatively connected. The memory 754 can include one or more non-transitory computer-readable storage mediums, such as RAM, ROM, EEPROM, EPROM, flash memory devices, magnetic disks, etc., and combinations thereof. The memory 754 can store data 756 and instructions 758 which are executed by the processor 752 to cause the training computing system 750 to perform operations. In some implementations, the training computing system 750 includes or is otherwise implemented by one or more server computing devices.

The training computing system 750 can include a model trainer 760 that trains the machine-learned models 720 and/or 740 stored at the user computing device 702 and/or the server computing system 730 using various training or learning techniques, such as, for example, backwards propagation of errors. For example, a loss function can be backpropagated through the model(s) to update one or more parameters of the model(s) (e.g., based on a gradient of the loss function). Various loss functions, such as mean squared error, likelihood loss, cross-entropy loss, hinge loss, and/or various other loss functions, can be used. Gradient descent techniques can be used to update the parameters over a number of training iterations iteratively.

In some implementations, performing backwards propagation of errors can include performing truncated backpropagation through time. The model trainer 760 can perform a number of generalization techniques (e.g., weight decays, dropouts, etc.) to improve the generalization capability of the models being trained.

In particular, the model trainer 760 can also train a teaching model 764 based on data included in the training data 762. The training data 762 can include synthetic images and user-generated suggested queries (e.g., labels) based on those synthetic images. The users can be instructed to generate queries that are information-seeking or have a high degree of variability to ensure that the teacher model 764 can generate example queries that have information-seeking characteristics and are diverse.

The teacher model 764 can then generate synthetic data that includes a plurality of synthetic examples. The synthetic data can be stored in the training data 762. Once the synthetic data has been stored in the training data 762, the model trainer 760, working with the teacher model 764, can train the query suggestion model and the query response model based on the synthetic data stored in the training data 762. The trainer data 762 can include log data, including log data from previous user queries and images similar to the images for which the queries were submitted. In this way, the specific images submitted by users are not included in the training data. However, similar images from a training set can be identified and used in the training.

The model trainer 760 includes computer logic utilized to provide the desired functionality. The model trainer 760 can be implemented in hardware, firmware, and/or software controlling a general-purpose processor. For example, in some implementations, the model trainer 760 includes program files stored on a storage device, loaded into memory, and executed by one or more processors. In other implementations, the model trainer 760 includes one or more sets of computer-executable instructions that are stored in a tangible computer-readable storage medium such as RAM hard disk or optical or magnetic media.

The network 780 can be any type of communications network, such as a local area network (e.g., intranet), wide area network (e.g., Internet), or some combination thereof and can include any number of wired or wireless links. In general, communication over the network 780 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 7 illustrates an example computing system that can be used to implement the present disclosure. Other computing systems can be used as well. For example, in some implementations, the user computing device 702 can include the model trainer 760 and the training data 762. In such implementations, the model(s) 770 can be trained and used locally at the user computing device 702. In some implementations, the user computing device 702 can implement the model trainer 760 to personalize the model(s) 720 based on user-specific data.

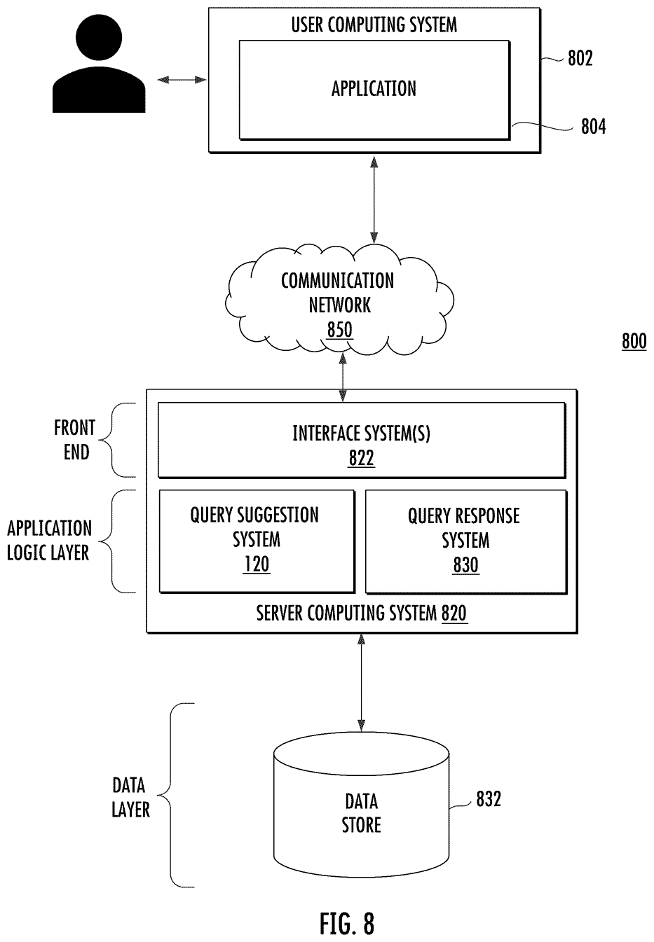

FIG. 8 depicts an example client-server environment 800 according to example embodiments of the present disclosure. The client-server system environment 800 includes one or more user computing systems 802 and a server computing system 820. One or more communication networks 850 can interconnect these components. The one or more communication networks 850 may be any of a variety of network types, including local area networks (LANs), wide area networks (WANs), wireless networks, wired networks, the Internet, personal area networks (PANs), or a combination of such networks.

A user computing system 802 can be one of, but is not limited to, a personal computing system, a smartphone, a smartwatch, a laptop computing device, and a tablet computing system. In some examples, the user computing system 802 can include one or more application(s) 804, such as search applications, communication applications, navigation applications, productivity applications, game applications, word processing applications, or other applications. The application(s) can include an image-based query application. The image-based query application can capture image data (e.g., images or video), display it on a screen associated with the user's computing device, and allow the user to generate queries associated with the image data.

In some examples, the image-based application can request a list of suggested queries from the computing system 820. The query suggestion system 120 can respond with a list of suggested queries (discussed in more detail below). The list of suggested queries can be displayed to a user via the application 804. The user can select a query from the list of suggested queries. Once the user has selected (or entered) a query, the user computing system 802 can use the image-based query application (or other applications) to send and receive requests to and from the server computing system 820. The user computing system 802 can transmit a request to the server computing system 820. The request can be a multimodal input query that includes the selected query. The server computing system 820 can provide the multimodal input query as input to a sequence processing model and return a model response to the user computing system 802.

As shown in FIG. 8, the server computing system 820 can generally be based on a three-tiered architecture, consisting of a front-end layer, application logic layer, and data layer. As is understood by skilled artisans in the relevant computer and Internet-related arts, each component shown in FIG. 8 can represent a set of executable software instructions and the corresponding hardware (e.g., memory and processor) for executing the instructions. To avoid unnecessary detail, various components and engines that are not germane to conveying an understanding of the various examples have been omitted from FIG. 8. However, a skilled artisan will readily recognize that various additional components, systems, and applications may be used with a computing system 802, such as that illustrated in FIG. 8, to facilitate additional functionality that is not specifically described herein. Furthermore, the various components depicted in FIG. 8 may reside on a single server computer or may be distributed across several server computers in various arrangements. Moreover, although server computing system 820 is depicted in FIG. 8 as having a three-tiered architecture, the various examples of embodiments are not limited to this architecture.

As shown in FIG. 8, the front end can consist of an interface system(s) 822, which receives communications from one or more user computing system 802 and communicates appropriate responses to the user computing system 802. For example, the interface system(s) 822 may receive requests in the form of Hypertext Transfer Protocol (HTTP) requests, or other web-based application programming interface (API) requests. The user computing system 802 may be executing conventional web browser applications or applications developed for a specific platform to include any of a wide variety of computing devices and operating systems.

As shown in FIG. 8, the data layer can include a data store 832. The data store 832 can store the data used to produce query suggestions in response to a request for query suggestions. For example, the data store 832 can include synthesized images, labeled data, log data, and synthetic data (e.g., data generated by a teacher model). In addition, the data store 832 can include information used by a query response system. For example, the data store 832 can include documents that can be used as context for generating a query response.

In some examples, the data store 832 can represent a plurality of distinct databases, each database storing a type of document. For example, the data store can include a plurality of documents, each indexed and/or embedded into an embedding space to allow for searchability or comparison to an input query. In some examples, the data store 832 (or a database associated with the data store 832) includes a plurality of embedded documents. Each embedded document can include information for a variety of topics. A search of the data store 832 can identify relevant documents and provide those documents to the server computing system 820.

The application logic layer can include application data that provides a wide range of other applications and services, allowing users to submit queries and receive responses. The application logic layer can include a query suggestion system 120 and a query response system 830.

When a user computing system 802 transmits a request for suggested queries, the server computing system 820, the interface system 822 can provide the request to the query suggestion system 110. The query suggestion system 120 can generate a model input based on the request. For example, if the request includes an image or representation of an image (such as an embedding or a textual description of the image), contextual information about the request, information about past interactions with the user, user intents, and other information come on so the model input can include that information. The model input can be a prompt.

The query suggestion system 120 can prompt one or more query suggestion models. Each query suggestion model can take the prompt as input, process the prompt and the information included therein, and output a model output. The model output can include one or more suggested queries. The query suggestion system 120 can collect the suggested queries into a list of queries and return the list to the user computing device.

When the user selects one of the suggested queries, the user computing device can transmit a query request to the server computing system 820. The server computing system 820 transmits the query request to the query response system. The query response system can generate a model input based on the query request, including the selected query couple, any information about an image or video, contextual information, and so on. The model input can be provided to the sequence processing model. The sequence processing model can generate a model output.

The model output can be transmitted to the user computing system 802 as part of the query response session. For example, the model output can include video and audio elements. The video content can be displayed on a screen, and a speaker can play the audio content. The audio content may include an explanation of the visuals depicted in the video content. In this way, the video and audio content can include different but related information for presentation to the user.

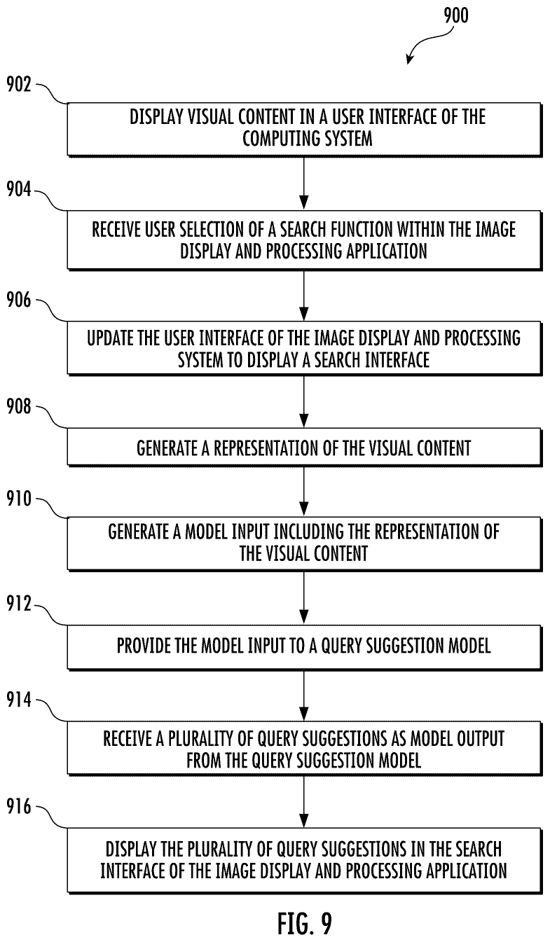

FIG. 9 is a flow diagram representing a process for generating query suggestions based on visual content in accordance with example embodiments of the present disclosure. The process can be performed by a computing system. The computing system can comprise one or more processors and one or more non-transitory computer-readable media that store instructions. In some examples, the computing system can display, at 902, visual content in a user interface of the computing system. In some examples, the user computing device is currently executing an image display and processing application. In some examples, the visual content is an image or a video.

The computing system can, at 904, receive user selection of a search function within the image display and processing application. The image display and processing application can enable a user to capture (e.g., using a camera integrated into the computing system) images, view those images, and request information about those images. In some examples, user selection of the search function comprises the user entering text in a search input field in the user interface of the application. For example, the user interface can include a search input field but only activates it for text input when the user clicks on or otherwise selects that input field.

In some examples, user selection of the search function comprises user selection of a search button displayed in the user interface. For example, the interface can include a search button. When the user selects the search button, the interface can be updated to display a search interface.

In response to receiving user selection of the search function, the computing system can, at 906, update the user interface of the image display and processing system to display a search interface. The computing system can, at 908, generate a representation of the visual content.

In some examples, the representation of the visual content can comprise an embedding of the image. The embedding can be a vector representation of the image in an embedding space. In some examples, the representation of the visual content can comprise a textual description of a semantic understanding of the visual content. In some examples, generating a representation of the visual content can comprise determining a portion of the visual content selected by the user. For example, a user can highlight, select, or otherwise indicate a particular portion of the visual content that is of interest to the user. The computing system can generate a representation of the portion of the visual content selected by the user.

The computing system can, at 910, generate a model input including the representation of the visual content. In some examples, the computing system can, at 912, provide the model input to a query suggestion model. In some examples, the model input can include one or more characters provided by the user to a search input field. The query suggestion model can be trained using synthetic data produced by a teacher model. The query suggestion model can comprise a plurality of distinct query suggestion models.

In some examples, the plurality of distinct query suggestion models are operated in parallel to produce a list of suggestions with reduced latency. In some examples, the query suggestion model is trained to prioritize information seeking queries.

The computing system can, at 914, receive a plurality of query suggestions as model output from the query suggestion model. The computing system can, at 916, display the plurality of query suggestions in the search interface of the image display and processing application. In some examples, the list of suggested queries are displayed below a search input field in the user interface of the application.

The computing system can receive user selection of a respective suggested query from the list of suggested queries. Responsive to receiving user selection of the respective suggested query from the list of suggested queries, the computing system can provide the respective suggested query to a query response model. The computing system can receive model output of the query response model. The computing system can provide the model output to the user interface.

After displaying the list of query suggestions, the computing system can receive additional user input into the search interface of the image display and processing application. The computing system can generate a new list of suggested queries based on the additional user input.

FIG. 10 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of a message generation model. Although various features, variations, and implementations described below are described with respect to machine-learned model(s) 1, it is to be understood that such features, variations, and implementations are to be understood as described with respect to the message generation model, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 9 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

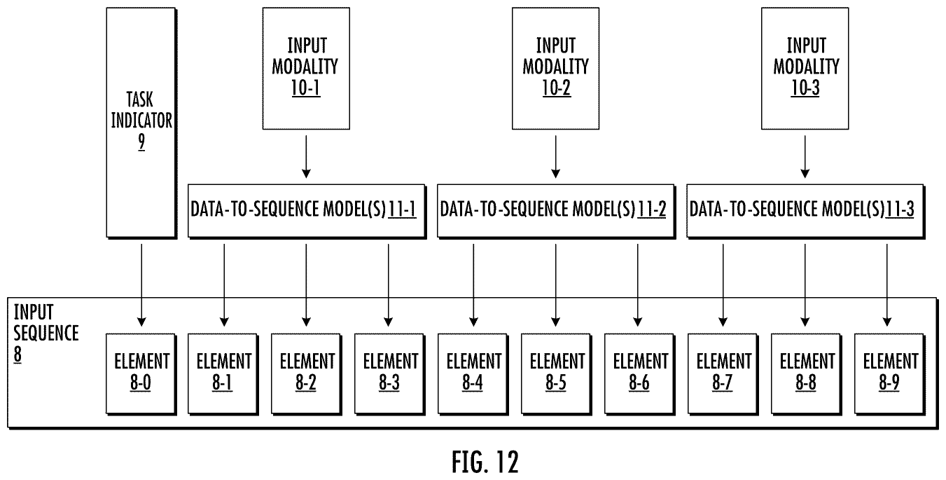

FIG. 12 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

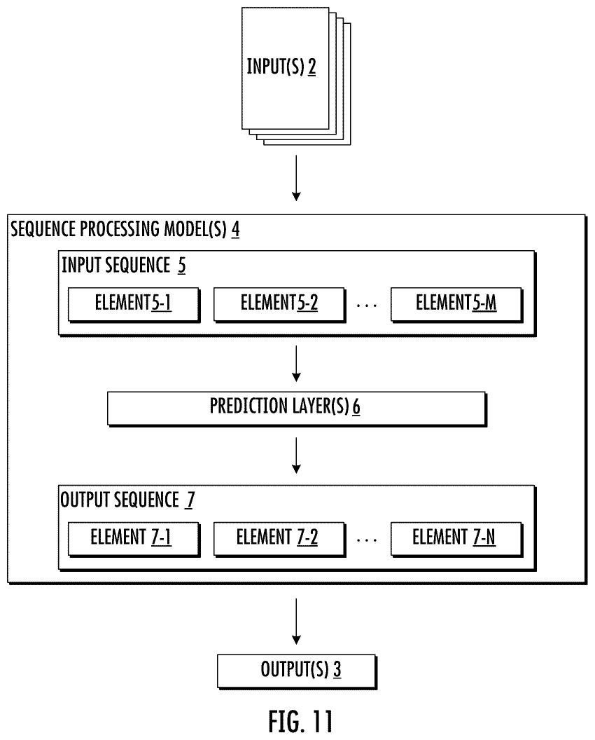

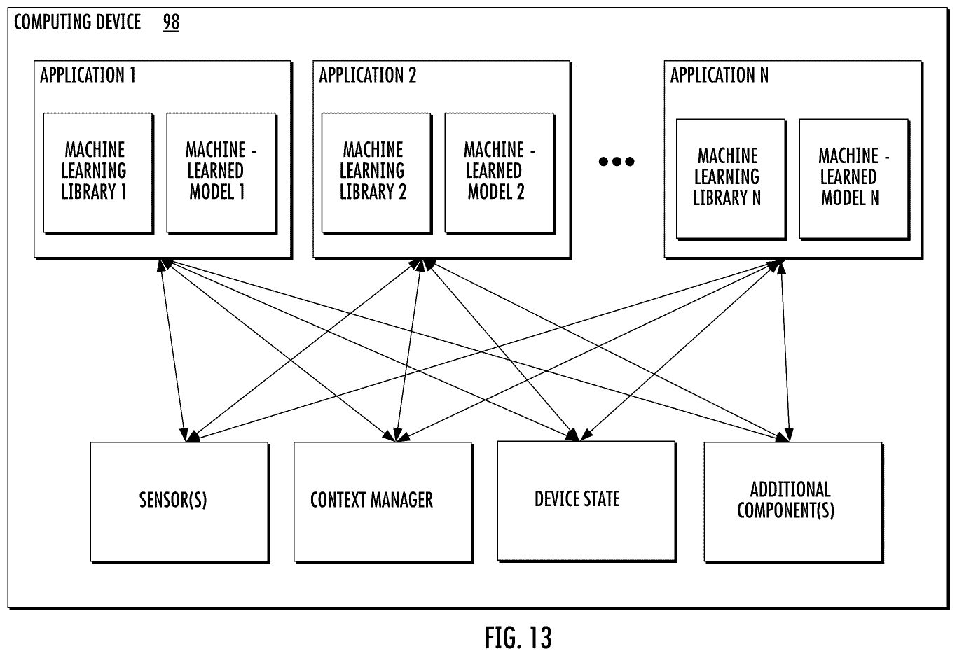

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine-learned library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

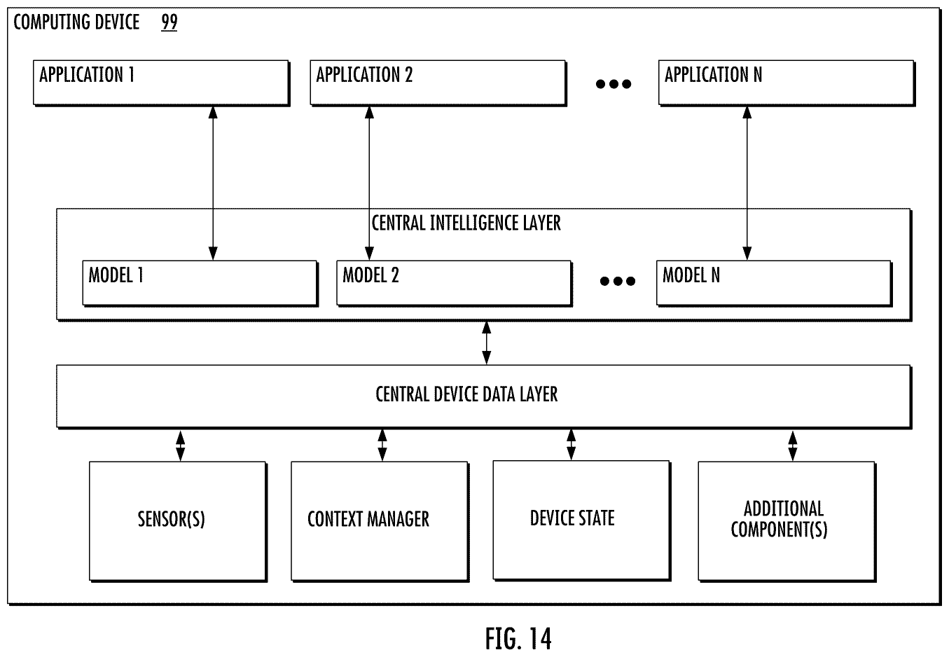

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 12, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for providing a query suggestion system, wherein the method comprises:
displaying, by a computing system with one or more processors, visual content in a user interface of an image display and processing application;
receiving, by the computing system, user selection of a search function within the image display and processing application;
updating, by the computing system, the user interface of the image display and processing application to display a search interface;
generating, by the computing system, a representation of the visual content;
generating, by the computing system, a plurality of model inputs including the representation of the visual content, wherein the content of each model input is different from the content of the other model inputs;
providing, by the computing system, each model input in the plurality of model inputs to a particular query suggestion model in a plurality of distinct query suggestion models simultaneously;
receiving, by the computing system, a plurality of query suggestions from the plurality of distinct query suggestion models based on the plurality of model inputs; and
displaying, by the computing system, the plurality of query suggestions in the search interface of the image display and processing application.

2. The computer-implemented method of claim 1, wherein user selection of the search function comprises a user entering text in a search input field in the user interface of the image display and processing application.

3. The computer-implemented method of claim 1, wherein user selection of the search function comprises user selection of a search button displayed in the user interface.

4. The computer-implemented method of claim 1, wherein the representation of the visual content comprises an embedding of an image included in the visual content.

5. The computer-implemented method of claim 4, wherein the embedding is a vector representation of the image included in the visual content in an embedding space.

6. The computer-implemented method of claim 1, wherein the representation of the visual content comprises a textual description of a semantic understanding of the visual content.

7. The computer-implemented method of claim 1, wherein the model input includes one or more characters provided by a user to a search input field.

8. The computer-implemented method of claim 1, wherein each query suggestion model in the plurality of distinct query suggestion models generates one or more query suggestions.

9. The computer-implemented method of claim 8, wherein the plurality of distinct query suggestion models are operated in parallel to produce a list of suggestions with reduced latency.

10. The computer-implemented method of claim 1, wherein the plurality of query suggestion models are trained to prioritize information seeking queries.

11. The computer-implemented method of claim 1, wherein the computing system is currently executing the image display and processing application.

12. The computer-implemented method of claim 1, wherein the plurality of query suggestion models are trained using synthetic data produced by a teacher model.

13. The computer-implemented method of claim 1, wherein the visual content is an image or a video.

14. The computer-implemented method of claim 1, wherein generating a representation of the visual content further comprises:
determining, by the computing system, a portion of the visual content selected by the user; and
generating, by the computing system, a representation of the portion of the visual content selected by a user.

15. The computer-implemented method of claim 1, wherein the plurality of suggested queries are displayed below a search input field in the user interface of the image display and processing application.

16. The computer-implemented method of claim 15, the method further comprising:
receiving, by the computing system, user selection of a respective suggested query from the plurality of suggested queries.

17. The computer-implemented method of claim 16, the method further comprising:
responsive to receiving user selection of the respective suggested query from the plurality of suggested queries:
providing, by the computing system, the respective suggested query to a query response model;
receiving, by the computing system, model output of the query response model; and
providing, by the computing system, the model output to the user interface of the computing system.

18. The computer-implemented method of claim 15, the method further comprising:
after displaying, by the computing system, the plurality of query suggestions in the search interface of the image display and processing application, receiving, by the computing system, additional user input into the search interface of the image display and processing application; and
generating, by the computing system, a new list of suggested queries based on the additional user input.

19. A computing system, comprising:
one or more processors; and
one or more non-transitory computer-readable media that store instructions wherein, when executed by the one or more processors, the instructions cause the one or more processors to perform operations, the operations comprising:
displaying visual content in a user interface of an image display and processing application;
receiving user selection of a search function within the image display and processing application;
updating the user interface of the image display and processing application to display a search interface;
generating a representation of the visual content;
generating a plurality of model inputs including the representation of the visual content, wherein the content of each model input is different from the content of the other model inputs;
providing each model input in the plurality of model inputs to a particular query suggestion model in a plurality of distinct query suggestion models simultaneously;
receiving a plurality of query suggestions from the plurality of query suggestion models based on the plurality of model inputs; and
displaying the plurality of query suggestions in the search interface of the image display and processing application.

20. One or more non-transitory computer-readable media that collectively store instructions that, when executed by one or more computing devices, cause the one or more computing devices to perform operations, the operations comprising:
accessing a plurality of synthesized images;
obtaining, for each synthesized image, one or more labels;
training a teacher model to generate synthetic suggested query data using the plurality of synthesized images and the one or more labels for each synthesized image;
generating, using the teacher model, the synthetic suggested query data;
creating suggested query training data by combining the synthetic suggested query data with existing query search log data; and
training a query suggestion model to generate suggested queries based on an image using the suggested query training data.
